(19) United States
(12) Patent Application Publication
(10) Pub. No.: US 2025/0367840 A1
(43) Pub. Date: Dec. 4, 2025

(54) OSCILLATING SAW CONNECTOR AND BLADE CONNECTED THERETO

(71) Applicant: Jiangsu Shengye Tool Technology Co., Ltd., Yangzhou (CN)

(72) Inventors: Hongming XU, Yangzhou (CN); Wei XU, Yangzhou (CN)

(73) Assignee: Jiangsu Shengye Tool Technology Co., Ltd., Yangzhou (CN)

(21) Appl. No.: 19/226,401

(22) Filed: Jun. 3, 2025

(30) Foreign Application Priority Data
Jun. 3, 2024 (CN) 202410705261.7

(51) Int. Cl. B26B 7/00; B26B 5/00; B26B 9/02

(52) U.S. Cl. CPC B26B 7/00; B26B 5/001; B26B 9/02

(57) ABSTRACT

The present invention relates to the technical field of cutting devices, and in particular, to an oscillating saw connector and a blade connected thereto, including a connector body. The connector body provided by the present invention is configured to connect an oscillating saw at one end and a blade at the other end, and kinetic energy transmitted from the oscillating saw drives the blade to move for cutting materials, featuring operational convenience and enhanced cutting force, as well as stable blade motion and improved dimensional accuracy during cutting; the connector body can accommodate different types of blades, and compared to conventional direct connection between an oscillating saw and a blade, no additional mounting holes are required to be formed in the blade for connection with the oscillating saw, thereby reducing the overall blade length to lower manufacturing costs, and decreasing replacement costs when the blade is damaged.

### CROSS-REFERENCE TO RELATED APPLICATIONS

The application claims priority to Chinese patent application No. CN202410705261.7, filed on Jun. 3, 2024, the entire contents of which are incorporated herein by reference.

### TECHNICAL FIELD

The present invention relates to the technical field of cutting devices, and in particular, to an oscillating saw connector and a blade connected thereto.

### BACKGROUND

Conventional cutting techniques for materials such as cardboard, paper, fabric, leather, cable sheaths, plastics, and soft metals (e.g., aluminum products) in the prior art mostly rely on manual tools, in which case a user grips a knife handle and performs repetitive up-and-down cutting motions. This method has drawbacks of insufficient cutting force, low efficiency, inconsistent dimensional accuracy, and poor operational convenience. To overcome these drawbacks, the present invention proposes a safe, adaptable, and efficient connector for connecting a manual blade to a powered oscillating saw.

### SUMMARY

To solve the problems mentioned in the background, the present invention is intended to provide an oscillating saw connector and a blade connected thereto.

In order to achieve the above objectives, the present invention provides the following technical solution: an oscillating saw connector, including a connector body, where the connector body includes a connecting plate A;
the connecting plate A has a connecting groove A at one end for connection with an oscillating saw, and a middle plate and an upper panel sequentially stacked at the other end;
the middle plate is provided with a clamping groove A for insertion of a blade body; and
a push block seat is mounted on a side of the upper panel away from the connecting plate A, where a push block is slidably mounted in the push block seat and has at least two states including a locked state and an unlocked state; in the locked state, the blade body inserted in the clamping groove A is locked in position; and in the unlocked state, the blade body is movable along the clamping groove A.

Preferably, the clamping groove A is configured in a parallelogram shape; a region of the blade body inserted into the clamping groove A defines an insertion region, while a region extending outside the clamping groove A defines a cutting region, where the insertion region has an area 2 to 2.5 times that of the cutting region; and the clamping groove A includes a clamping surface A, while the blade body includes a mounting surface, where the clamping surface A abuts against the mounting surface.

Preferably, the push block moves in a direction identical or opposite to a movement direction of the blade body along the connecting groove A; the push block is connected to a spring A and includes an inclined shoulder on a side away from the spring A for pressing against a steel ball; an upper end surface of the push block is provided with an inclined edge including a plurality of arc-shaped recesses; the upper panel, the middle plate, and the connecting plate A are each provided with a slot for the steel ball to move in a direction perpendicular to the blade body; the blade body is provided with an engagement slot configured to engage with the steel ball; and the connecting plate A, the middle plate, the upper panel, and the push block seat are fixedly connected by a bolt A.

An oscillating saw connector, including a connector body, where the connector body includes a connecting plate B;
the connecting plate B has a connecting groove B at one end for connection with an oscillating saw, and a fixing base mounted at the other end;
the fixing base is provided with a clamping groove B configured to engage with a blade body, and a push button is slidably connected within the fixing base; and
the push button has at least two states including a fixed state and a released state, where in the fixed state, the blade body inserted in the clamping groove B is fixed in position; and in the released state, the blade body is slidable relative to the clamping groove B.

Preferably, the connecting plate B is provided with fixed recess holes that engage with bosses arranged in the fixing base; a region of the blade body inserted into the clamping groove B defines an insertion region, while the remaining region defines a cutting region, where the insertion region has an area 2 to 2.5 times that of the cutting region; and the clamping groove B includes a clamping surface B configured to be flush with a mounting surface of the blade body.

Preferably, a block step disposed on an inner side of the push button engages with an engagement slot formed in the blade body; the push button is movable in a direction perpendicular to the blade body and is connected to a spring B; a spring plate is arranged at a position corresponding to the clamping groove B in the fixing base; and the connecting plate B and the fixing base are fixedly connected by a bolt B.

A blade for connection with an oscillating saw connector, including a blade body and a blade sleeve mounted thereon, where a cavity in the blade sleeve is identical to a cutting region of the blade body, and the blade sleeve is provided with a through-hole.

A blade for connection with an oscillating saw connector, including a blade body, where the blade body includes a blade A configured in an isosceles trapezoidal shape; the blade A includes two engagement slots respectively defined as a left engagement slot and a right engagement slot; two cutting heads A are arranged at two corner portions of the blade A; and the blade A forms a first deflection angle A ranging between 50° and 65°.

A blade for connection with an oscillating saw connector, including a blade body, where the blade body includes a blade B configured in an isosceles trapezoidal shape; and the blade B includes two engagement slots respectively defined as a left engagement slot and a right engagement slot.

Preferably, two cutting heads B are arranged at two corner portions of the blade B and configured in a hook shape; and the blade B forms a first deflection angle B ranging between 50° and 65°.

Compared with the prior art, the present invention has the following beneficial effects:
I: the present invention provides a connector body configured to connect an oscillating saw at one end and a blade at the other end, and kinetic energy transmitted from the oscillating saw drives the blade to move for cutting materials, featuring operational convenience and enhanced cutting force, as well as stable blade motion and improved dimensional accuracy during cutting;
II: the connector body of the present invention can accommodate different types of blades, and compared to conventional direct connection between an oscillating saw and a blade, no additional mounting holes are required to be formed in the blade for connection with the oscillating saw, thereby reducing the overall blade length to lower manufacturing costs, and decreasing replacement costs when the blade is damaged;
III: the present invention provides a blade A and a blade B, each equipped with dual cutting heads capable of cutting materials during operation, and when the cutting head on one side becomes damaged or dull, the blade is reversible to apply the cutting head on the other side, thereby improving practicability; and
IV: the present invention provides a blade A and a blade B, respectively forming a first deflection angle A and a first deflection angle B between 50° and 65°; an insertion region of each blade has an area 2 to 2.5 times that of a cutting region thereof; and both the blade A and the blade B are sufficiently supported during material cutting operations to prevent bending while maintaining smooth cutting performance.

### BRIEF DESCRIPTION OF THE DRAWINGS

FIG. 1 is a first schematic structural diagram of Embodiment I of the present invention;

FIG. 2 is a second schematic structural diagram of Embodiment I of the present invention;

FIG. 3 is a sectional view of a portion D-D in FIG. 2 of the present invention;

FIG. 4 is a schematic structural diagram of Embodiment I of the present invention with a connecting plate A removed;

FIG. 5 is a schematic diagram of an internal structure of a clamping groove A according to an embodiment of the present invention;

FIG. 6 is a first schematic structural diagram of Embodiment II of the present invention;

FIG. 7 is a second schematic structural diagram of Embodiment II of the present invention;

FIG. 8 is a sectional view of a portion E-E in FIG. 7 of the present invention;

FIG. 9 is a schematic structural diagram of Embodiment II of the present invention with a connecting plate B removed;

FIG. 10 is a first schematic structural diagram of Embodiment III of the present invention;

FIG. 11 is a second schematic structural diagram of Embodiment III of the present invention;

FIG. 12 is a first schematic structural diagram of Embodiment IV of the present invention;

FIG. 13 is a second schematic structural diagram of Embodiment IV of the present invention; and

FIG. 14 is a schematic structural diagram of a conventional blade.

Reference signs used in the figures: 101: connecting plate A; 102: middle plate; 103: upper panel; 104: push block seat; 105: push block; 106: steel ball; 107: spring A; 108: bolt A; 109: connecting groove A; 110: clamping groove A; 111: clamping surface A;
201: connecting plate B; 202: fixing base; 203: push button; 204: spring B; 205: spring plate; 206: bolt B; 207: connecting groove B; 208: clamping groove B; 209: clamping surface B;
3: blade body; 301: blade A; 3011: cutting head A; 302: blade B; 3021: cutting head B;
401: left engagement slot; 402: right engagement slot;
5: blade sleeve; and 501: through-hole.

### DETAILED DESCRIPTION OF THE EMBODIMENTS

The following clearly and completely describes the technical solutions in the embodiments of the present invention with reference to the accompanying drawings in the embodiments of the present invention. Apparently, the described embodiments are merely some rather than all of the embodiments of the present invention. Based on the embodiments in the present invention, all other embodiments obtained by those of ordinary skill in the art without making creative efforts shall fall within the scope of protection of the present invention.

### Embodiment I

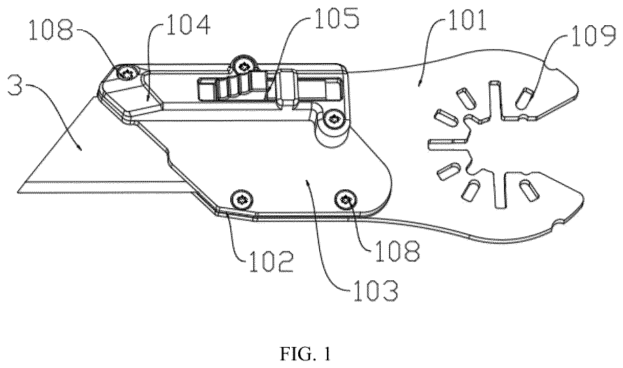

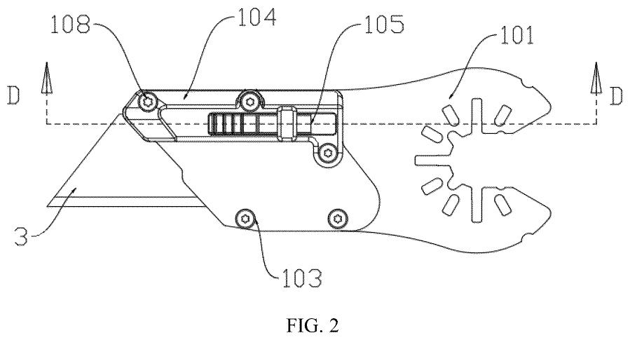

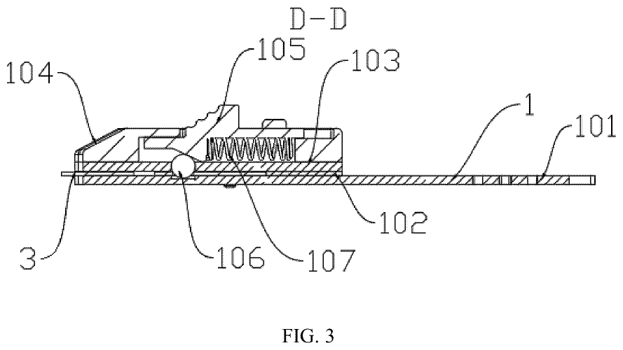

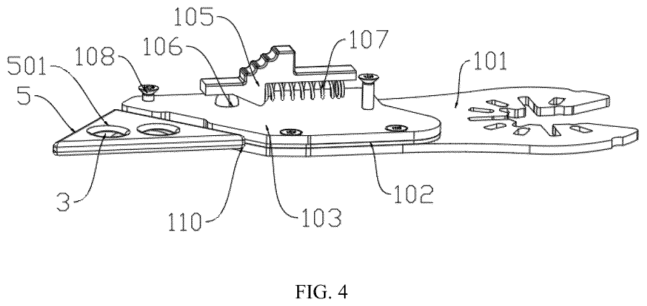

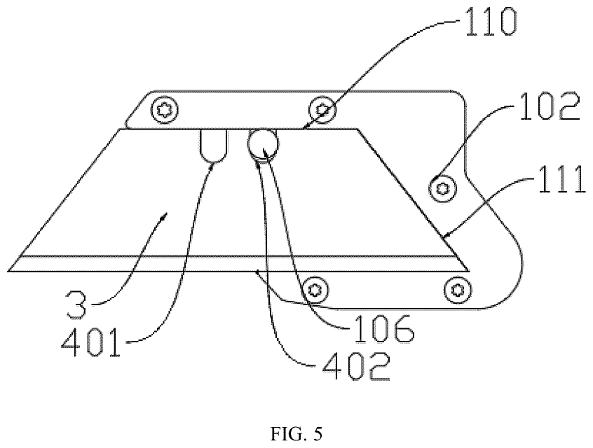

Referring to FIGS. 1-5, an oscillating saw connector and a blade connected thereto are provided, including: a connector body implemented as a connector A1 (i.e., connector A denoted by 1 in FIGS. 1-5) and a blade body 3, where the connector body (i.e., connector A1) includes: a connecting plate A 101, a middle plate 102, an upper panel 103, a push block seat 104, a push block 105, a steel ball 106, a spring A 107, and a bolt A 108;
the connecting plate A 101 has a connecting groove A 109 at one end for connection with an oscillating saw. As shown in FIGS. 1-5, the end containing the connecting groove A 109 is configured in a circular shape, while the other end away from the connecting groove A 109 is configured in a rectangular shape, and smooth transition is achieved from the circular end to the rectangular end to form a whole through an arc-shaped interface; the middle plate 102 and the upper panel 103 are sequentially stacked at the other end; and the connecting plate A 101 is made of 65Mn steel with a Rockwell hardness of 38-42 HRC, providing flatness, durability, and deformation resistance;
the middle plate 102 is provided with a clamping groove A 110 configured in a parallelogram shape for receiving the blade body 3; a region of the blade body 3 inserted into the clamping groove A 110 defines an insertion region, while a region extending outside the clamping groove A 110 defines a cutting region, where the insertion region has an area 2 to 2.5 times that of the cutting region; forces acting on the cutting region are transferred through the insertion region to other components; by maintaining the insertion region at 2 to 2.5 times the area of the cutting region, the exposed cutting region remains rigid during cutting, resisting bending deformation; and the clamping groove A 110 in the middle plate 102 has openings in both upper and lower sides, which are respectively sealed by the upper panel 103 and the connecting plate A 101 on the upper and lower sides to collectively form the enclosed clamping groove A 110 for retaining the blade body 3. It should be noted that the clamping groove A 110 includes a clamping surface A 111, while the blade body 3 includes a mounting surface, where the clamping surface A 111 abuts against the mounting surface;
to fix the blade body 3 in position when inserted into the clamping groove A 110, the push block seat 104 is mounted on a side of the upper panel 103 away from the connecting plate A 101, where the push block 105 is slidably mounted in the push block seat 104 and has at least two states including a locked state and an unlocked state; in the locked state, the blade body 3 inserted in the clamping groove A 110 is locked in position; and in the unlocked state, the blade body 3 is movable along the clamping groove A 110;
furthermore, the push block 105 moves in a direction identical or opposite to a movement direction of the blade body 3 along the connecting groove A 109, and is connected to the spring A 107 that provides an elastic force. As shown in FIG. 3, the spring A 107 can drive the push block 105 toward the left, and the push block 105 includes an inclined shoulder on a side away from the spring A 107 for pressing against the steel ball 106; an upper end surface of the push block 105 is provided with an inclined edge including a plurality of arc-shaped recesses; and the inclined edge and the arc-shaped recesses can collectively increase friction to facilitate finger pressing;
specifically, the upper panel 103, the middle plate 102, and the connecting plate A 101 are each provided with a slot for the steel ball 106 to move in a direction perpendicular to the blade body 3, and the blade body 3 is provided with an engagement slot configured to engage with the steel ball 106. As shown in FIG. 3, the steel ball 106 is movable upward and downward: when the push block 105 is pushed rightward and the blade body 3 is pulled, the blade body 3 can press against the steel ball 106 to move it upward, at which time the push block 105 and the blade body 3 are in an unlocked state; and when the push block 105 is released, it moves leftward under the elastic force of the spring A 107, and the inclined shoulder inside the push block 105 presses against the steel ball 106 to move it downward, causing the steel ball 106 to engage with the engagement slot in the blade body 3, at which time the push block 105 and the blade body 3 are in a locked state;
the connecting plate A 101, the middle plate 102, the upper panel 103, and the push block seat 104 are fixedly connected by the bolt A 108. It should be noted that five bolts A 108 are provided, both the middle plate 102 and the upper panel 103 are configured in a parallelogram shape substantially similar to that of the connecting groove A 109, and among the five bolts A 108, three are respectively disposed at three corner portions of the parallelogram. As shown in FIG. 1, the remaining two bolts are roughly disposed at the last corner portion of the parallelogram. To more stably secure the push block seat 104, two bolts A 108 are respectively mounted at upper and lower ends of the right side of the push block seat 104; and a blade sleeve 5 is mounted on the blade body 3; a cavity in the blade sleeve 5 is identical
to the cutting region of the blade body 3; and the blade sleeve 5 is provided with a through-hole 501. The through-hole 501 is configured to facilitate visual inspection of the blade body 3. The blade sleeve 5 encloses the blade body 3 and covers the cutting heads when the blade body 3 is not in use, thereby preventing injury to human limbs or damage to other objects.

### Embodiment II

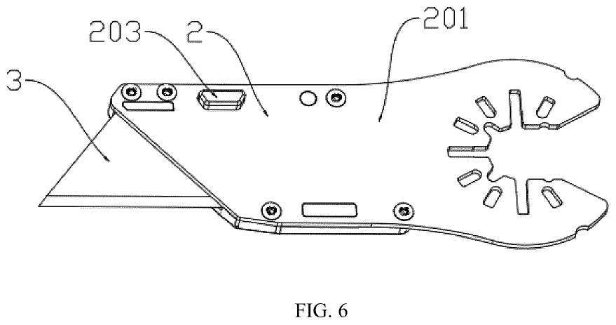

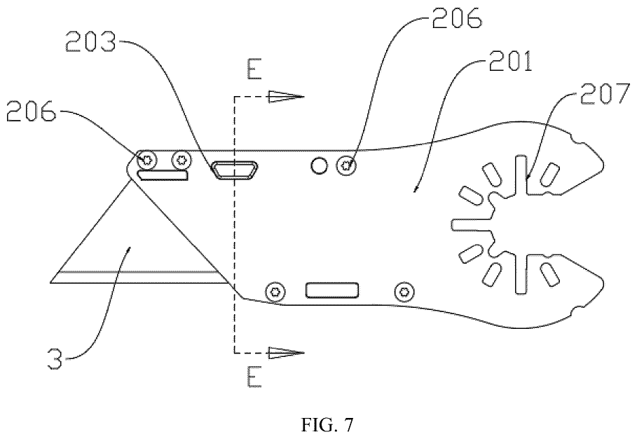

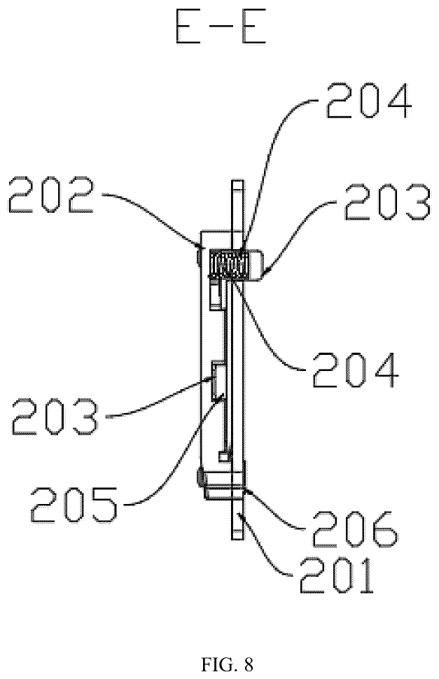

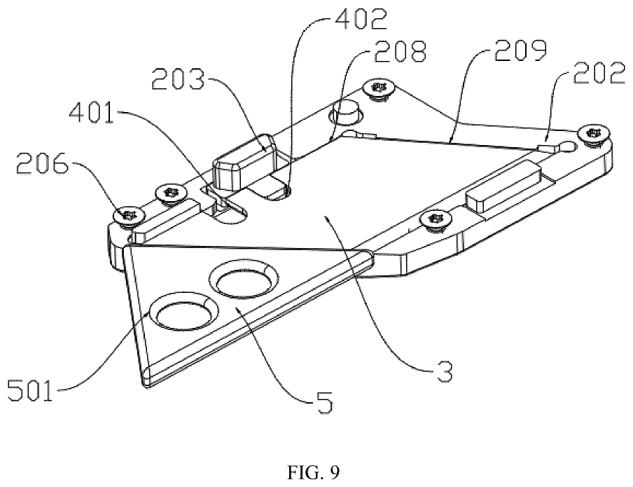

Referring to FIGS. 6-9, an oscillating saw connector and a blade connected thereto are provided, including: a connector body implemented as a connector B 2 (i.e., connector B denoted by 2 in FIGS. 6-9) and a blade body 3, where the connector body (i.e., connector B 2) includes: a connecting plate B 201, a fixing base 202, a push button 203, a spring B 204, a connecting groove B 207, a clamping groove B 208, and a clamping surface B 209;
the connecting plate B 201 has the connecting groove B 207 at one end for connection with an oscillating saw, and the fixing base 202 mounted at the other end. It should be noted that the connecting plate B 201 is provided with fixed recess holes that engage with multiple bosses arranged in the fixing base 202, and the bosses include both circular bosses and rectangular bosses; the fixing base 202 is provided with the clamping groove B 208 configured to engage
with the blade body 3; a region of the blade body 3 inserted into the clamping groove B 208 defines an insertion region, while the remaining region defines a cutting region, where the insertion region has an area 2 to 2.5 times that of the cutting region; the clamping groove A 110 and the clamping groove B 208 serve identical functions, both being configured to mount the blade body 3 and having identical internal areas and shapes; the clamping groove B 208 includes the clamping surface B 209 configured to be flush with a mounting surface of the blade body 3; and the push button 203 is slidably connected within the fixing base 202;
it should be noted that a block step disposed on an inner side of the push button 203 engages with an engagement slot formed in the blade body 3; the push button 203 is movable in a direction perpendicular to the blade body 3 and has at least two states including a fixed state and a released state, where in the fixed state, the blade body 3 inserted in the clamping groove B 208 is fixed in position and cannot move; and in the released state, the blade body 3 is slidable relative to the clamping groove B 208;
furthermore, the push button 203 is connected to the spring B 204, and a spring plate 205 is arranged at a position corresponding to the clamping groove B 208 in the fixing base 202. The spring plate 205 is disposed on a side of the blade body 3 adjacent to the fixing base 202 and can provide a compressive force that increases radial pressure between the blade body 3 and an inner wall of the clamping groove B 208, thereby more securely locking the blade body 3 in position in the clamping groove B 208;
still furthermore, the connecting plate B 201 and the fixing base 202 are fixedly connected by the bolt B 206. It should be noted that four bolts B 206 are provided, the fixing base 202 is configured in a parallelogram shape similar to that of the connecting groove B 208, and the four bolts B 206 are respectively disposed at four corner portions of the parallelogram; and
it should be noted that a blade sleeve 5 is mounted on the blade body 3; a cavity in the blade sleeve 5 is identical to the cutting region of the blade body 3; and the blade sleeve 5 is provided with a through-hole 501. The through-hole 501 is configured to facilitate visual inspection of the blade body 3. The blade sleeve 5 encloses the blade body 3 and covers the cutting heads when the blade body 3 is not in use, thereby preventing injury to human limbs or damage to other objects.

### Embodiment III

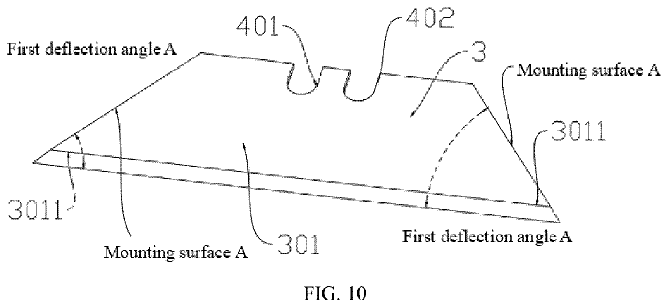

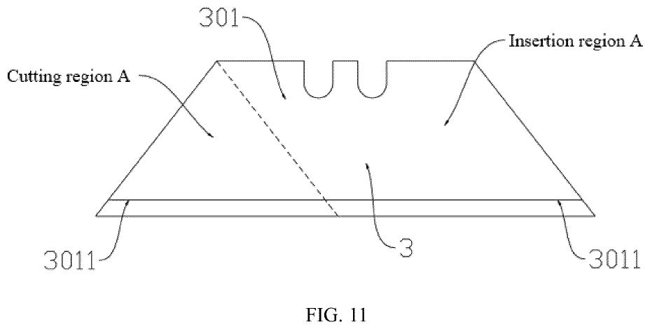

As shown in FIGS. 10-11, the blade body 3 mentioned in Embodiments I and II is provided, including a blade A 301 configured in an isosceles trapezoidal shape; the blade A 301 includes two engagement slots respectively defined as a left engagement slot 401 and a right engagement slot 402; and two cutting heads A 3011 are arranged at two corner portions of the blade A 301. The two cutting heads A 3011 are interchangeably usable (specifically, by reversing or rotating the blade A 301, either of the two cutting heads A 3011 can be oriented outward, such that the cutting region is not fixed but selectable between the two cutting heads A 3011 for adjustable operation as needed). During the interchange process, the position of the blade A 301 is reversed or rotated, causing a change in the engagement position, thus necessitating provision of the left engagement slot 401 and the right engagement slot 402, which are respectively used for fixation when either of the two cutting heads A 3011 is engaged;
it should be noted that the blade A 301 forms a first deflection angle A ranging between 50° and 65°. The first deflection angle A of the blade A 301 fits with the clamping surfaces A 111 and B 209, and is critically correlated with the size of the cutting region A. During the practical implementation, it has been found that when the first deflection angle A ranges between 50° and 65°, the feeding process of the blade A 301 by pinching the cutting region A to push/pull the blade A 301 achieves easy force application, and the cutting force provided by the cutting region A during cutting remains stable; and

FIG. 11 shows the distribution of the insertion region A and the cutting region A of the blade A 301, where the insertion region A is configured in a parallelogram shape identical to that of the connecting grooves A 109 and B 207.

### Embodiment IV

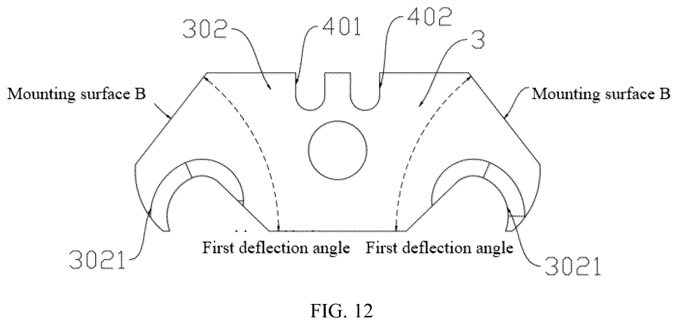

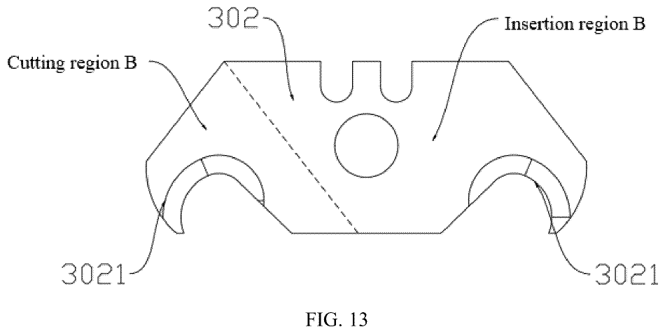

As shown in FIGS. 12-13, the blade body 3 mentioned in Embodiments I and II is provided, including a blade B 302 configured in an isosceles trapezoidal shape; the blade B 302 includes two engagement slots respectively defined as a left engagement slot 401 and a right engagement slot 402; and two cutting heads B 3021 are arranged at two corner portions of the blade B 302 and configured in a hook shape. The two cutting heads B 3021 are interchangeably usable (specifically, by reversing or rotating the blade B 302, either of the two cutting heads B 3021 can be oriented outward, such that either of the two cutting heads B 3021 can be selected for use as needed). During the interchange process, the position of the blade B 302 is reversed or rotated, causing a change in the engagement position, thus necessitating provision of the left engagement slot 401 and the right engagement slot 402, which are respectively used for fixation when either of the two cutting heads B 3021 is engaged;
it should be noted that the blade B 302 forms a first deflection angle B ranging between 50° and 65°; and

FIG. 13 shows the distribution of the insertion region B and the cutting region B of the blade B 302, where the insertion region B is configured in a parallelogram shape identical to that of the connecting grooves A 109 and B 207.

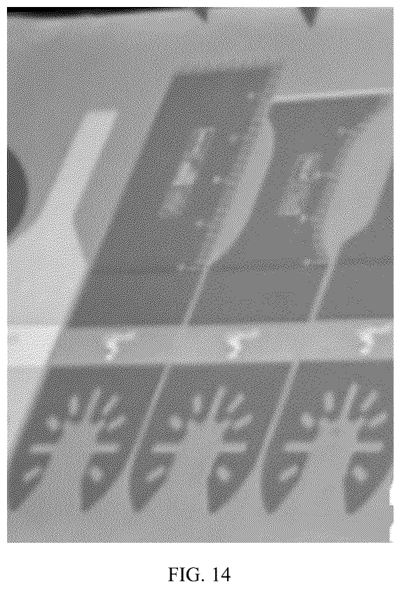

A conventional blade, as shown in FIG. 14, is directly connected to an oscillating saw and requires mounting holes for connection with the oscillating saw. To facilitate installation onto the oscillating saw, the blade's length must be appropriately increased (requiring additional space to accommodate the mounting holes), resulting in higher manufacturing costs. When damaged, the entire blade must be discarded, leading to higher replacement costs.

Although the embodiments of the present invention have been shown and described, it will be appreciated by those of ordinary skill in the art that various changes, modifications, substitutions, and variations can be made to these embodiments without departing from the principle and spirit of the present invention, and the scope of the present invention is defined by the appended claims and their equivalents.

What is claimed is:

1. An oscillating saw connector, comprising a connector body, wherein the connector body comprises a connecting plate A (101);
the connecting plate A (101) has a connecting groove A (109) at one end for connection with an oscillating saw, and a middle plate (102) and an upper panel (103) sequentially stacked at the other end;
the middle plate (102) is provided with a clamping groove A (110) for insertion of a blade body (3); and
a push block seat (104) is mounted on a side of the upper panel (103) away from the connecting plate A (101), wherein a push block (105) is slidably mounted in the push block seat (104) and has at least two states comprising a locked state and an unlocked state; in the locked state, the blade body (3) inserted in the clamping groove A (110) is locked in position; and in the unlocked state, the blade body (3) is movable along the clamping groove A (110).

2. The oscillating saw connector of claim 1, wherein the clamping groove A (110) is configured in a parallelogram shape; a region of the blade body (3) inserted into the clamping groove A (110) defines an insertion region, while a region extending outside the clamping groove A (110) defines a cutting region, wherein the insertion region has an area 2 to 2.5 times that of the cutting region; and the clamping groove A (110) comprises a clamping surface A (111), while the blade body (3) comprises a mounting surface, wherein the clamping surface A (111) abuts against the mounting surface.

3. The oscillating saw connector of claim 2, wherein the push block (105) moves in a direction identical or opposite to a movement direction of the blade body (3) along the connecting groove A (109); the push block (105) is connected to a spring A (107) and comprises an inclined shoulder on a side away from the spring A (107) for pressing against a steel ball (106); an upper end surface of the push block (105) is provided with an inclined edge comprising a plurality of arc-shaped recesses; the upper panel (103), the middle plate (102), and the connecting plate A (101) are each provided with a slot for the steel ball (106) to move in a direction perpendicular to the blade body (3); the blade body (3) is provided with an engagement slot configured to engage with the steel ball (106); and the connecting plate A (101), the middle plate (102), the upper panel (103), and the push block seat (104) are fixedly connected by a bolt A (108).

4. An oscillating saw connector, comprising a connector body, wherein the connector body comprises a connecting plate B (201);
the connecting plate B (201) has a connecting groove B (207) at one end for connection with an oscillating saw, and a fixing base (202) mounted at the other end;
the fixing base (202) is provided with a clamping groove B (208) configured to engage with a blade body (3), and a push button (203) is slidably connected within the fixing base (202); and
the push button (203) has at least two states comprising a fixed state and a released state, wherein in the fixed state, the blade body (3) inserted in the clamping groove B (208) is fixed in position; and in the released state, the blade body (3) is slidable relative to the clamping groove B (208).

5. The oscillating saw connector of claim 4, wherein the connecting plate B (201) is provided with fixed recess holes that engage with bosses arranged in the fixing base (202); a region of the blade body (3) inserted into the clamping groove B (208) defines an insertion region, while the remaining region defines a cutting region, wherein the insertion region has an area 2 to 2.5 times that of the cutting region; and the clamping groove B (208) comprises a clamping surface B (209) configured to be flush with a mounting surface of the blade body (3).

6. The oscillating saw connector of claim 5, wherein a block step disposed on an inner side of the push button (203) engages with an engagement slot formed in the blade body (3); the push button (203) is movable in a direction perpendicular to the blade body (3) and is connected to a spring B (204); a spring plate (205) is arranged at a position corresponding to the clamping groove B (208) in the fixing base (202); and the connecting plate B (201) and the fixing base (202) are fixedly connected by a bolt B (206).

7. A blade for connection with the oscillating saw connector of claim 1, comprising a blade body (3), wherein a blade sleeve (5) is mounted on the blade body (3); a cavity in the blade sleeve (5) is identical to a cutting region of the blade body (3); and the blade sleeve (5) is provided with a through-hole (501).

8. A blade for connection with the oscillating saw connector of claim 1, comprising a blade body (3), wherein the blade body (3) comprises a blade A (301) configured in an isosceles trapezoidal shape; the blade A (301) comprises two engagement slots respectively defined as a left engagement slot (401) and a right engagement slot (402); two cutting heads A (3011) are arranged at two corner portions of the blade A (301); and the blade A (301) forms a first deflection angle A ranging between 50° and 65°.

9. A blade for connection with the oscillating saw connector of claim 1, comprising a blade body (3), wherein the blade body (3) comprises a blade B (302) configured in an isosceles trapezoidal shape; and the blade B (302) comprises two engagement slots respectively defined as a left engagement slot (401) and a right engagement slot (402).

10. The blade for connection with the oscillating saw connector of claim 9, wherein two cutting heads B (3021) are arranged at two corner portions of the blade B (302) and configured in a hook shape; and the blade B (302) forms a first deflection angle B ranging between 50° and 65°.
